(19) United States
(12) Patent Application Publication
(10) Pub. No.: US 2005/0109467 A1
(43) Pub. Date: May 26, 2005

(54) Curtain with a plurality of base units

(76) Inventor: Tsu Ming Huang, Chang Hua Hsien (TW)

Correspondence Address: Tsu Ming Huang, 235 Chung-Ho, Box 8-24, Taipei, TW

(21) Appl. No.: 10/719,951

(22) Filed: Nov. 24, 2003

(51) Int. Cl. E06B 3/48

(52) U.S. Cl. 160/84.01

(57) ABSTRACT

A curtain with a plurality of base units comprises a plurality of curtaining units. Each curtain unit comprises a base unit at a middle part of the curtain unit; two sets of middle sleeves connected at two opposite sides of the base unit; two folding portions connected at outer sides of the base unit, two net units being connected at outer sides of the folding portions, two edge sleeves set formed by a plurality of edge sleeves being connected at the outer sides of the net units; two middle bars; each middle bar passing through each middle sleeves of a respective one of the two middle sleeve set; and two edge bars being arranged; each edge bar passing through each edge sleeves of a respective one of the two edge sleeve sets.

### FIELD OF THE INVENTION

The present invention relates to curtains, and particular to a curtain with a plurality of base units.

### BACKGROUND OF THE INVENTION

There are several kinds of curtains are used, such as cloth curtains, venetian shades, etc. Curtains are necessary for shielding a window so as to protect the privacy of those inside the door. Moreover, the curtains can provide a beautiful outlook to the window, even the building having the window. In general, the folding and releasing of curtains are controlled by ropes.

In general, adjustable draperies and/or blinds are mounted to permanently sealed windows, sliding glass windows and doors, casement windows, and the like to selectively cover the window. However, new homes and rental properties are often unfurnished and, initially, do not include window draperies or blinds. Since draperies are somewhat expensive and are usually purchased for long-term use, homeowners and renters may take several weeks or more to actually purchase and install permanent draperies. This is especially true if the draperies are custom-made. In addition, choosing permanent draperies often takes time because draperies are available in a wide variety of fabrics, designs, and color schemes. Consequently, new homeowners and renters may face both lack of privacy and an inability to block light shining through the windows for a long period of time.

Moreover, the curtains are often not closed tightly so that dust, sands, mosquito, flies or other insects will fly into the curtains so as to pollute the indoor environment or harm the human body.

### SUMMARY OF THE INVENTION

Accordingly, the primary object of the present invention is to provide a curtain with a plurality of base units which comprises a plurality of curtaining units. Each curtain unit comprises a base unit at a middle part of the curtain unit; two sets of middle sleeves connected at two opposite sides of the base unit; two folding portions connected at outer sides of the base unit, two net units being connected at outer sides of the middle sleeves, two edge sleeves set formed by a plurality of edge sleeves being connected at the outer sides of the net units; two middle bars; each middle bar passing through each middle sleeves of a respective one of the two middle sleeve set; and two edge bars being arranged; each edge bar passing through each edge sleeves of a respective one of the two edge sleeve sets.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a perspective view showing the embodiment of the present invention.

FIG. 3 is a plane view of the embodiment of the present invention.

FIG. 4 is a lateral view of the present invention.

FIG. 4A shows a schematic view about the adjustment of the slope of the curtain unit according to the present invention.

FIG. 4B shows another schematic view about the adjustment of the slope of the curtain unit according to the present invention.

FIG. 5 is a lateral schematic view of the present invention.

FIG. 5A is a schematic view showing the operation of the folding of the present invention.

FIG. 5B is another schematic view showing the operation of the folding of the present invention.

FIG. 6 shows one application of the present invention.

FIG. 7 shows another application of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

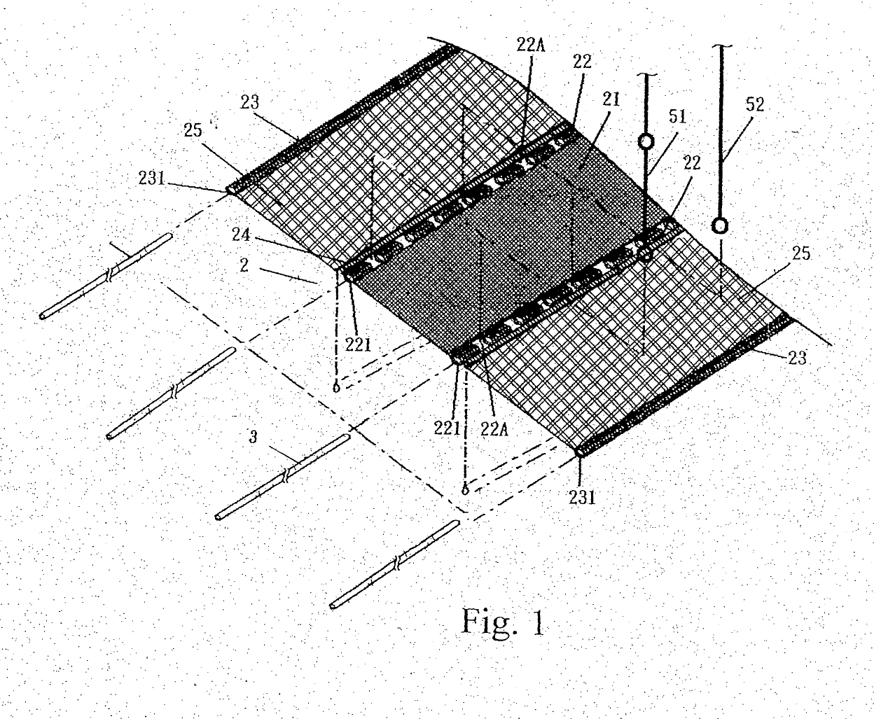

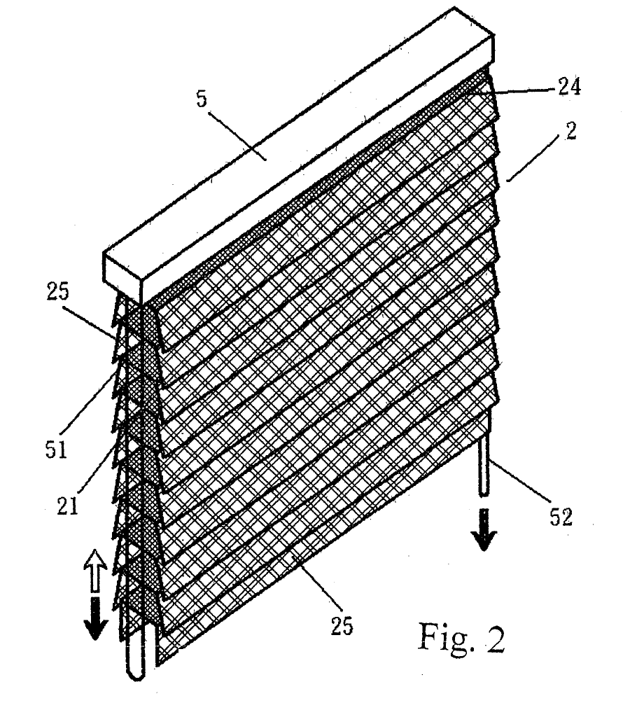

With reference to FIGS. 1 to 3, the curtain of the present invention comprises a plurality of curtain units 2, two ropes 51, 52, a supporting bar 5. Each curtain unit 2 comprises the following elements.

A base unit 21 is at the middle part of the curtain unit 2.

Two sets 221 of middle sleeves 22 are connected at two opposite sides of the base unit 21. Each set 221 is formed by a plurality of middle sleeves 22 which are arranged along an edge of the base unit 21 and are spaced away so that the sections containing the middle sleeve sets 221 are formed as notches 22A.

Two folding portions 24 are connected at outer sides (the sides not adjacent the base unit 21) of the meddle sleeve sets 221. Each of the two folding portions 24 is connected with a respective one of the middle sleeve set 221.

Two net units 25 are connected at outer sides of the folding portions 24, respectively, namely, at the side not adjacent the middle sleeves 22.

Two edge sleeves set 231 formed by a plurality of edge sleeves 23 are connected at the outer sides of the net units 25, namely, at the sides not adjacent to the folding portions 24.

Two middle bars 3 are arranged. Each middle bar 3 passes through each middle sleeves 22 of a respective one of the two middle sleeve sets 221.

Two edge bars 3 are arranged. Each edge bar 4 passes through each edge sleeves 22 of a respective one of the two edge sleeve sets 231.

A supporting rod 5 is arranged above a plurality of base units 21.

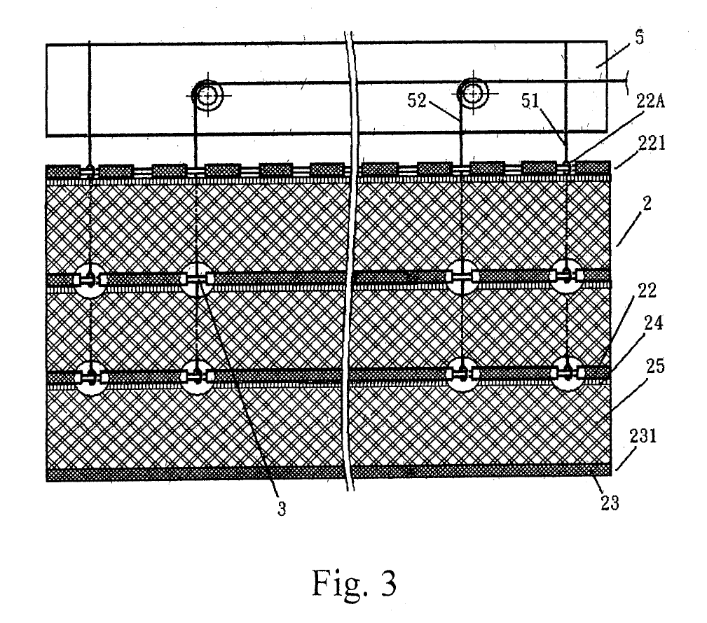

Two adjusting ropes 51 pass two ends of the base unit 21, respectively, referring to FIG. 3). At the connections of the adjusting ropes 51 and the middles bars, buckles are used to movably buckle the ropes to the edges bars 3. One end of each adjusting rope 51 is fixed to the supporting rod 5 and the other end of the adjusting rope 51 is fixed to a lowest base unit 21.

Two folding ropes 52 are arranged. One end of each folding rope 52 is movably fixed to the lowest base unit 21 by a buckle and the other end of the folding rope 52 passes through a pulley fixed to the supporting rod 5.

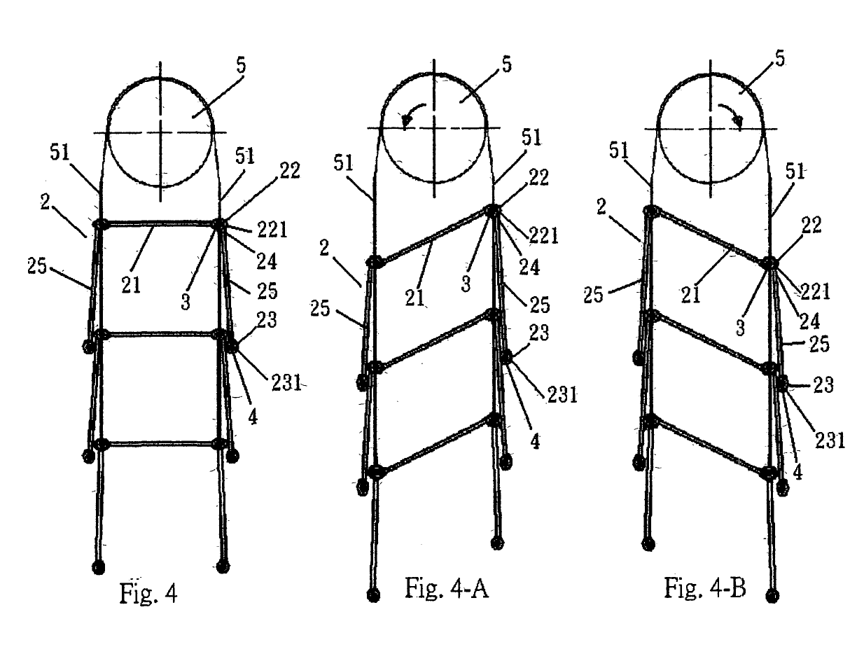

Referring to FIG. 4, the operation of the present invention is illustrated. When the supporting rod 5 is pulled, see FIG. 4A or FIG. 4B, it will show that one ends of the middle bars 3 are pulled downward and other ends of the middle bars 3 moves upwards with the same extent. Thereby, the slope of the base units 21 is controllable. Despite the orientation of the base units 21, the net units 25 are all in vertical condition so that often one side of the curtain is sealed for preventing the mosquito, insects, dust, etc. to enter into the inside of the curtain.

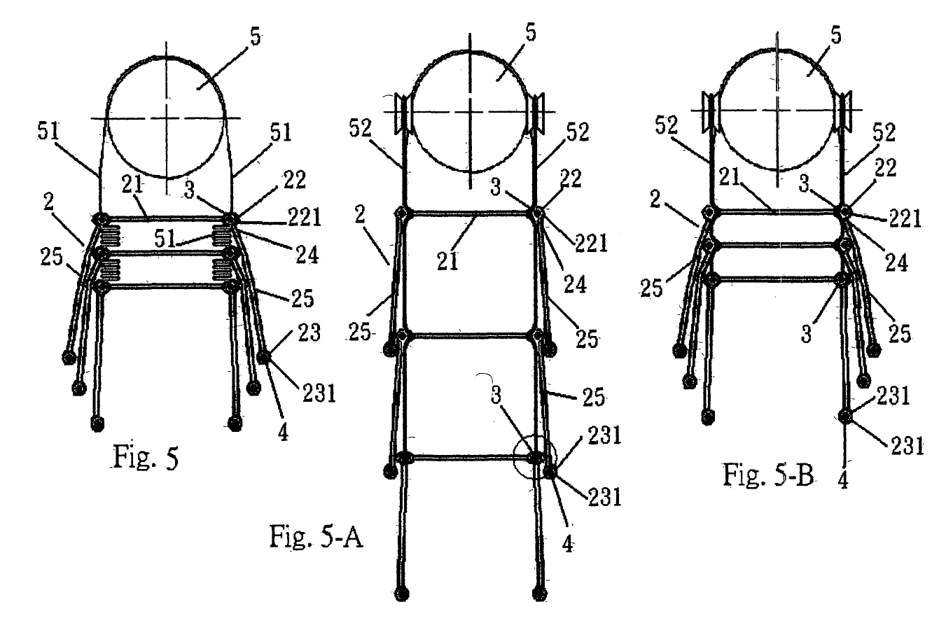

With reference to FIG. 5, when the two folding ropes 52 are pulled at the same time, all the curtain units 2 and net units 25 are overlapped.

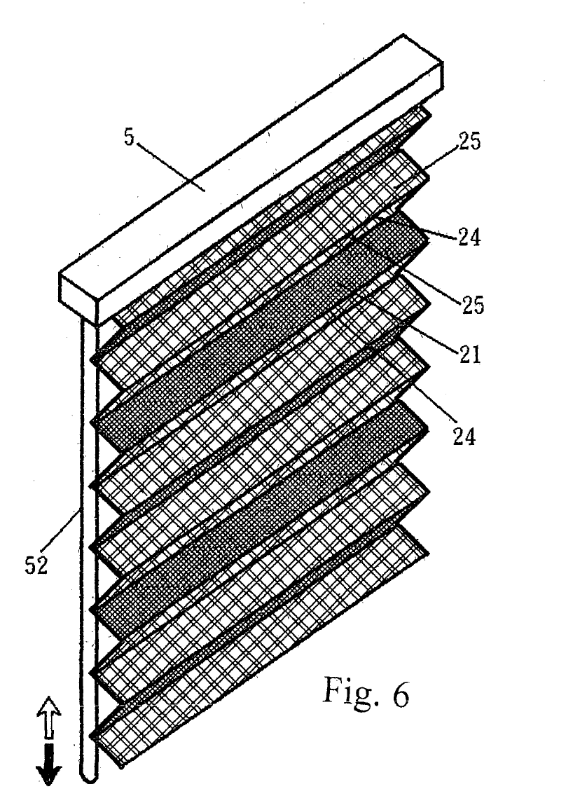

With reference to FIG. 6, one application of the present invention is illustrated, where the curtain units 2 are arranged one adjacent the other and the supporting rod 5 is connected to one edge sleeve set 231 of the uppermost base unit 21.

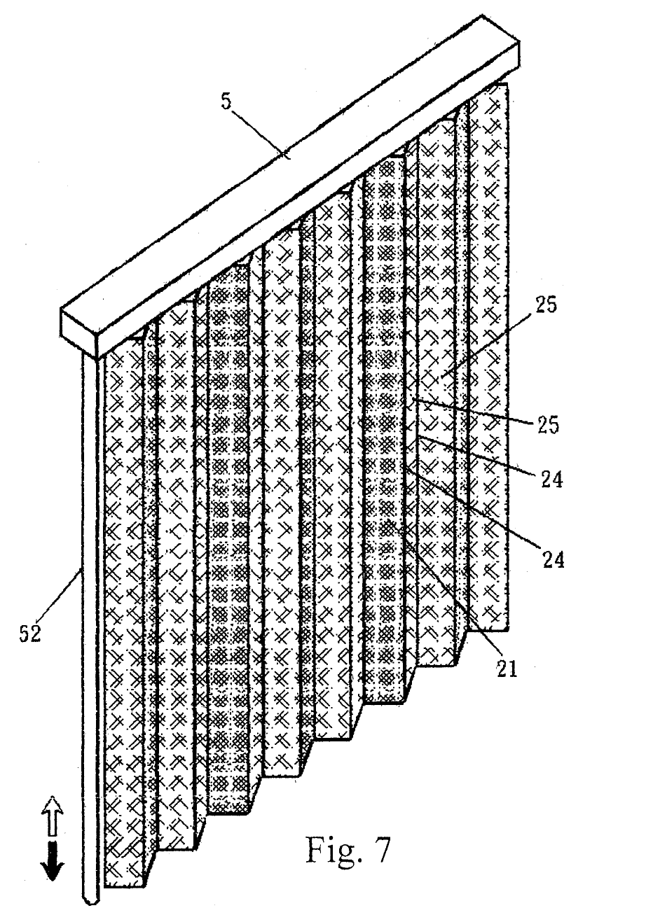

Referring to FIG. 7, another application of the present invention is illustrated, where the curtain units 2 are arranged one adjacent the other and the supporting rod 5 is connected to one side of each curtain unit 2.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A curtain with a plurality of base units comprising:
a plurality of curtaining units, each curtain unit comprising:
a base unit at a middle part of the curtain unit;
two sets of middle sleeves connected at two opposite sides of the base unit; each set being formed by a plurality of middle sleeves which are arranged along an edge of the base unit and are spaced away; so that the sections containing the middle sleeve sets being formed as notches
two folding portions connected at outer sides of the middle sleeve sets, namely at the sides not adjacent to the base units; each of the two folding portions being connected with a respective one of the middle sleeve set;
two net units being connected at outer sides of the folding portions, respectively, namely, at the side not adjacent the middle sleeve sets;
two edge sleeves set formed by a plurality of edge sleeves being connected at the outer sides of the net units, namely, at the sides not adjacent to the folding portions;
two middle bars; each middle bar passing through each middle sleeves of a respective one of the two middle sleeve sets; and
two edge bars; each edge bar passing through each edge sleeves of a respective one of the two edge sleeve sets.

2. The curtain of claim 1, the curtain further comprising:
a supporting rod being arranged above a plurality of base units;
two adjusting ropes passing two ends of the base unit, respectively, at the connections of the adjusting ropes and the middles bars, a buckle being used to movably buckle the ropes to the edges bars; one end of each adjusting rope being fixed to the supporting rod and the other end of the adjusting rope being fixed to a lowest base unit;
two folding ropes being arranged; one end of each folding rope being movably fixed to the lowest base unit by a buckle and the other end of the folding rope passing through a pulley fixed to the supporting rod.

3. The curtain of claim 1, wherein the curtain units, are arranged one adjacent the other and the support ing rod is connected to one edge sleeve set of the uppermost base unit.

4. The curtain of claim 1, wherein the curtain units are arranged one adjacent the other and the supporting rod is connected to one side of each curtain unit.
